(19) United States
(12) Patent Application Publication
(10) Pub. No.: US 2025/0163980 A1
(43) Pub. Date: May 22, 2025

(54) ARTICULATING PISTON INSERT

(71) Applicant: ALCON COMPONENTS LIMITED, Staffordshire (GB)

(72) Inventors: David Charles CLEGG, Leamington Spa (GB); Garry James WISEMAN, Warwick (GB)

(21) Appl. No.: 18/861,841

(22) PCT Filed: Apr. 14, 2023
(86) PCT No.: PCT/GB2023/051006

§ 371 Date: Oct. 30, 2024

(30) Foreign Application Priority Data
May 9, 2022 (GB) 2206757.3

(51) Int. Cl. F16D 65/18; F16D 65/097; F16D 125/06

(52) U.S. Cl. CPC F16D 65/183; F16D 65/0971; F16D 2125/06

(57) ABSTRACT

A piston for the actuation of a brake pad, the piston comprising a body having a base end, a pad end and a side wall formed therebetween, an axis X extending from the base end to the pad end, the pad end having a cap contact surface at a non-zero angle relative to the axis of the body; a cap movably secured to the body at the pad end, the cap being arranged over the cap contact surface and having a pad contact face and an opposite body contact face; and a resilient member arranged between the body and the cap; wherein, on application of a braking force, the cap is arranged in an initial position where the cap contact surface of the body is spaced apart from the body contact face of the cap, whereby the cap is moveable transversely relative to the axis of the body into an intermediate position; and wherein the cap is moveable axially relative to the body from the intermediate position into a final position where the cap contact surface contacts the body contact face such that movement of the cap transversely relative to the axis of the body is restrained in the final position.

### FIELD

The present invention relates to a piston for the actuation of a brake pad, the piston having an articulating insert. It also relates to a brake caliper assembly having such a piston.

### BACKGROUND

The efficiency of vehicular disc brakes is of vital importance. Not only does efficiency allow for greater braking force (and thus shorter stopping distances), but a greater efficiency can ensure that the brakes are more reliable and have a longer usable period.

Referring to FIGS. 1 to 4, there is shown an example of a brake caliper 10. The brake caliper 10 sits astride a brake disc (not shown). The caliper comprises a caliper body 12 defining two pairs of cylinders 14, 16 on each side of the disc, with pistons 20 disposed within each cylinder 14, 16. Two opposed brake pads 18 are arranged either side of the disc, each pad 18 having a disc facing surface 19a for contact with the pad and a piston facing surface 19b for contact with pistons 20. In other caliper arrangements, a single piston may be provided on each side of the caliper. Both multiple and single piston such calipers are known as “opposed piston” calipers. Alternatively, one or more pistons may be provided on one side of the caliper with no pistons provided on the other side, known as “sliding piston” calipers. The present invention is applicable to both opposed piston and sliding piston calipers.

Such disc brakes are at their most efficient when the disc facing surface 19a and piston facing surface 19b are parallel to the plane of the brake disc. This ensures that the maximum surface area of contact between the pad 18 and disk is achieved and the braking force is applied evenly, resulting in the lowest pad work rate for a given braking force.

However, inconsistent wear of the pad 18 can result in an angled disc facing surface 19a of the pad 18 relative to the disc surface. When the pad 18 has an angled disc facing surface 19a as a result of inconsistent wear, after it contacts the disc under braking force, the angled disc facing surface 19a conforms to the surface of the disc which results in the piston facing surface 19b of the pad 18 being arranged at a non-zero angle to the front face of the brake piston or pistons 20. This results in a period of use wherein the contact area between the pad 18 and the disc is reduced. Also, on initial application of the brakes, where multiple pistons 20 are provided on a side of the disc, one of the pistons 20 has to travel further to apply braking force. Furthermore, the angled disc facing surface 19a of the pad 18 means that the piston 20 contacts the pad 18 at an angle creating a point contact which is sub-optimal for the transmission of braking force. All of this results in a less responsive brake and increased brake actuation travel.

When multiple pistons 20 are provided on a side of the disc and one of the pistons 20 has to travel further to apply braking force, said braking force is applied at an angle to the axis of motion of the piston 20. This angled force can cause the piston 20 to tilt within the cylinder 14, 16 such that pressure is applied to the walls of the cylinders 14, 16. This can damage other components of the brake caliper 10, such as seals. In some cases, the tilt is sufficient for the side wall of the piston to contact the cylinder wall. This contact is deleterious since it introduces an unwanted friction in properly applying the brake and can damage the cylinder and/or piston walls.

The present invention seeks to overcome or at least mitigate these problems by providing a device in which the angle of the pad face is matched to that of the disc. The present invention also seeks to provide such a device that is reliable, easy to manufacture and cost effective.

### SUMMARY

A first aspect of the invention provides a piston for the actuation of a brake pad, the piston comprising a body having a base end, a pad end and a side wall formed therebetween, an axis extending from the base end to the pad end, the pad end having a body contact surface at a non-zero angle relative to the axis of the body; a cap movably secured to the body at the pad end, the cap being arranged over the body contact surface and having a pad contact face and an opposite piston contact face; and a resilient member arranged between the body and the cap; wherein the cap is arranged in an initial position where the body contact surface of the body is spaced apart from the piston contact face of the cap whereby the cap is moveable transversely relative to the axis of the body into an intermediate position; and wherein the cap is moveable axially relative to the body from the intermediate position into a final position where the body contact surface contacts the pad contact face such that movement of the cap transversely relative to the axis of the body is restrained.

In this way, the piston can apply force across the entirety of the pad contact face, regardless of the angle of the disc facing surface of the brake pad relative to the brake disc. This ensures that the pad facing surfaces of the pistons remain square during usage of the brake. This means that there is no reduction in the contact area between the pad and the disc, and that multiple pistons have to travel the same distance to apply the braking force. This ensures the force is exerted along the axis of the piston. Moreover, the centre of pressure is moved away from the taper such that any hotspots created by the taper are reduced, thus reducing further uneven pad wear. As such, the lifespans of the pad and the piston are increased and brake actuation travel improved.

The body contact surface or the cap contact face may have a roughened texture. In some examples, both the body contact surface and the cap contact face have a roughened texture. In this way, friction between the body and the cap is increased, so that the contact angle is “remembered” by the cap between applications of braking force.

The angle of the transverse movement of the cap relative to the axis X may be different to the angle of the body contact surface relative to the axis X. The angle of transverse movement of the cap relative to the axis may be smaller than the angle of the body contact surface relative to the axis. Alternatively, an angle of transverse movement of the cap relative to the axis may be greater than the angle of the body contact surface relative to the axis.

The body contact surface may be curved, the curve having a radius of curvature and a centre of curvature, the centre of curvature being on the axis X. The transverse movement of the cap may occur on a radius of rotation, whereby the rate of change of the angle of the transverse movement of the cap relative to the axis is non-equal to the rate of change of the angle of the body contact surface relative to the axis.

By tuning these respective angles or rates of change of angle, different effects may be achieved. Where the angle or rate of change of angle of transverse movement is shallower than the angle or less than the rate of change of angle of the body contact surface, increased transverse movement of the cap relative to the axis increases the gap between the cap and the body contact surface. On the other hand, where the angle or rate of change of angle of transverse movement is steeper than the angle or greater than the rate of change of angle of the body contact surface, increased transverse movement of the cap relative to the axis decreases the gap between the cap and the body contact surface. In the former, greater axial travel of the cap is thus required for increasing transverse displacement before contact occurs between cap and body whereas, in the latter, the amount of axial travel required before contact occurs is reduced. The skilled person can tune these respective angles or radii in order to achieve appropriate desired effects.

In another embodiment, one of the angle of transverse movement of the cap or the angle of the body contact surface may be fixed and the other may vary relative to the axis, for example by being formed as a curve.

The pad contact face of the cap may have at least one groove formed therein for cooling purposes.

The base end and side wall of the body may define an interior space of the body. The body may have a protrusion extending from the base end into the interior space. The resilient member may be arranged within the interior space of the body. In this way, the device is formed in a compact manner, whilst ensuring the position of the resilient member is maintained.

The resilient member may be a spring. More specifically, the resilient member may be a conical spring having a wide end and a narrow end, the resilient member being arranged such that the wide end is closer to the cap than the narrow end. In this way, there is minima force exerted on the cap tending to return it to a position normal relative to the axis X.

The resilient member may be arranged such that it extends around the protrusion of the body. In this way, the positioning of the resilient member is maintained.

The cap may be movably secured to the body at the pad end via securing means. The securing means may be a bolt. More specifically, the securing means may be a bolt that is screwed into a threaded bore in the pad end of the protrusion of the body. In this way, the device is simple to assemble and disassemble for maintenance. Furthermore, the use of a bolt and threaded bore means it is easy to adjust the freedom of movement of the cap relative to the body.

The piston may further comprise a washer arranged between the securing means and the cap. The washer may have an outer face and a cap contact face, the cap contact face being in contact with the cap in the initial position but not in the second position. In this way, the washer assists in keeping the cap secured in the initial position. The cap preferably includes a washer contact surface. The cap contact face of the washer and the washer contact surface of the cap are preferably arranged at a non-zero angle relative to the axis X. In such a way, the interface between the cap contact face of the washer and the washer contact surface of the cap may define the angle or rate of change of angle of the transverse movement of the cap, at least in the first stage of the transverse movement of the cap.

Other aspects of the invention provide a brake caliper assembly including the above-described piston and a vehicle including such a brake caliper assembly.

### BRIEF DESCRIPTION OF THE DRAWINGS

Embodiments will now be described, by way of example only, with reference to the accompanying figures in which:

FIG. 1 is a perspective view of a brake system according to the present invention;

FIG. 2 is the view of FIG. 1 without the brake disc shown;

FIG. 3 is a cross-section of the assembly of FIG. 2 showing the brake pad;

FIG. 4 is the view of FIG. 3 without the pad present

FIG. 5 is the view of FIG. 4 without the pistons present;

FIG. 6 is an exploded perspective view of a piston according to the present invention;

FIG. 7 is a perspective view of a piston body of the piston of FIG. 6;

FIG. 8 is a perspective cross-section view of the piston body of FIG. 7;

FIG. 9 is a side cross-section view of the piston body of FIG. 7;

FIG. 10 is a perspective view of a piston cap of the piston of FIG. 6;

FIG. 11 is a perspective cross-section view of the piston cap of FIG. 10;

FIG. 12 is a side cross-section view of the piston cap of FIG. 10;

FIG. 13 is a perspective view of a washer of the piston of FIG. 6;

FIG. 14 is a perspective cross-section view of the washer of FIG. 13;

FIG. 15 is a side cross-section view of the washer of FIG. 13;

FIG. 16 is a side cross-section view of a piston according to the present invention in an initial position;

FIG. 17 is a side cross-section view of the piston of FIG. 16 having moved between the initial position and a second position;

FIG. 18 is a side cross-section view of the piston of FIG. 16 in the second position;

FIGS. 19 & 20 are side cross section views of a piston according to a second embodiment of the invention in the initial and second positions respectively;

FIGS. 21, 22 and 23 are side cross section views of a piston according to a third embodiment of the invention in the initial, middle and second positions respectively;

FIG. 24 is an exploded perspective view of a piston according to a fourth embodiment of the invention;

FIGS. 25 to 27 are side cross section views of the piston in FIG. 24 in the initial, middle and second positions, respectively;

FIGS. 28 AND 29 are schemative representations of pistons in accordance with the invention interacting with an unworn brake pad and a tapered brake pad.

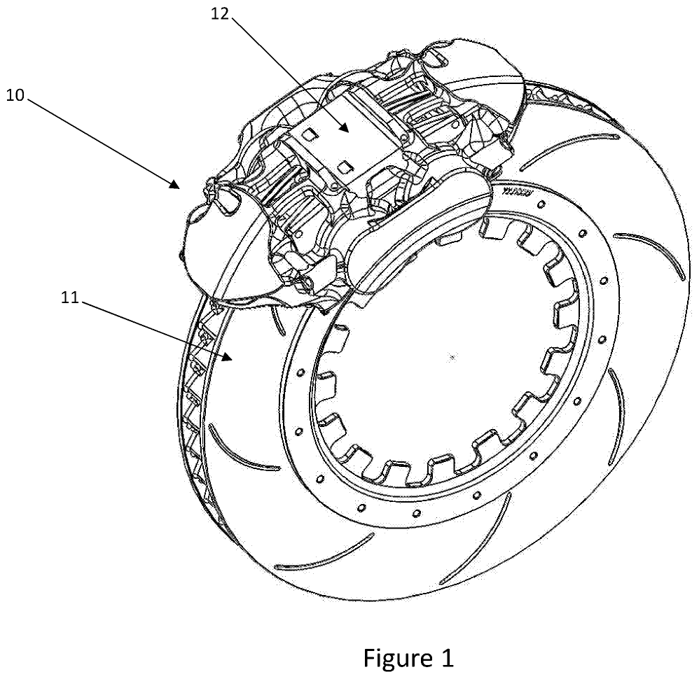

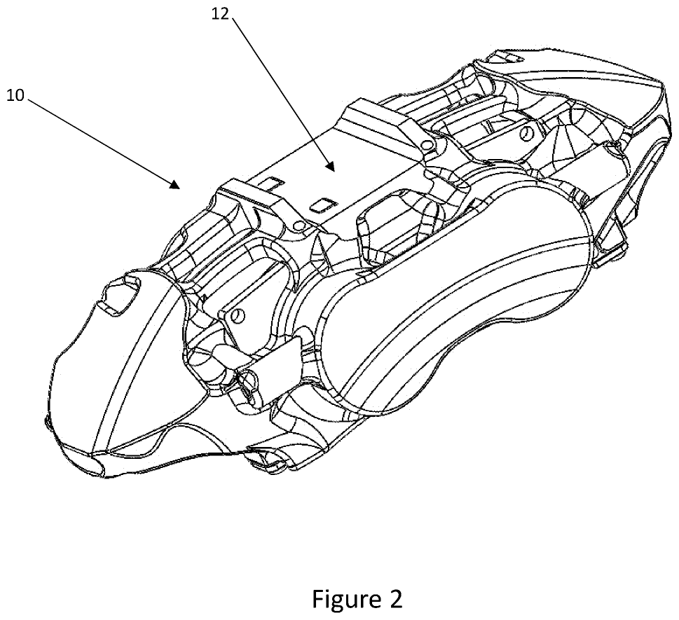

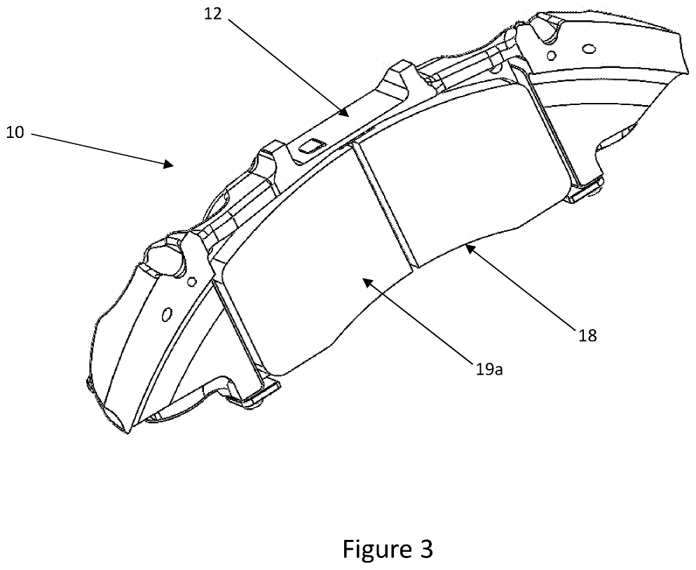

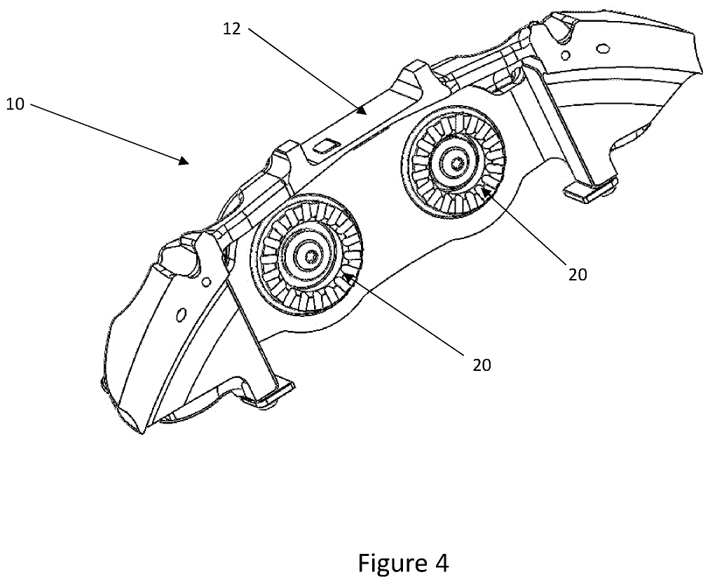

### DETAILED DESCRIPTION OF EMBODIMENTS

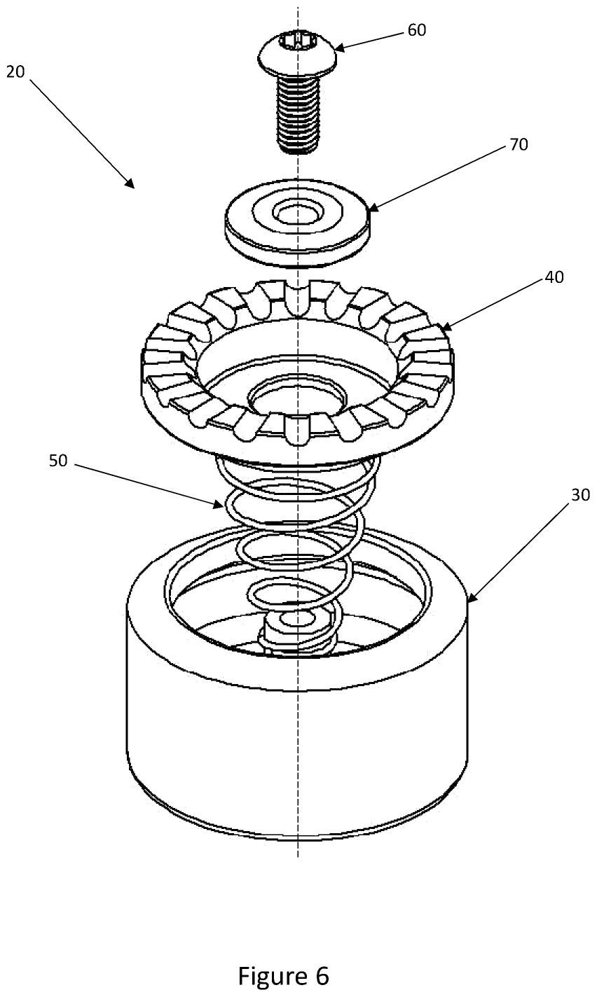

In FIG. 6 a piston 20 in accordance with the invention comprises a piston body 30, a cap 40, a resilient member 50, securing means 60 and a washer 70.

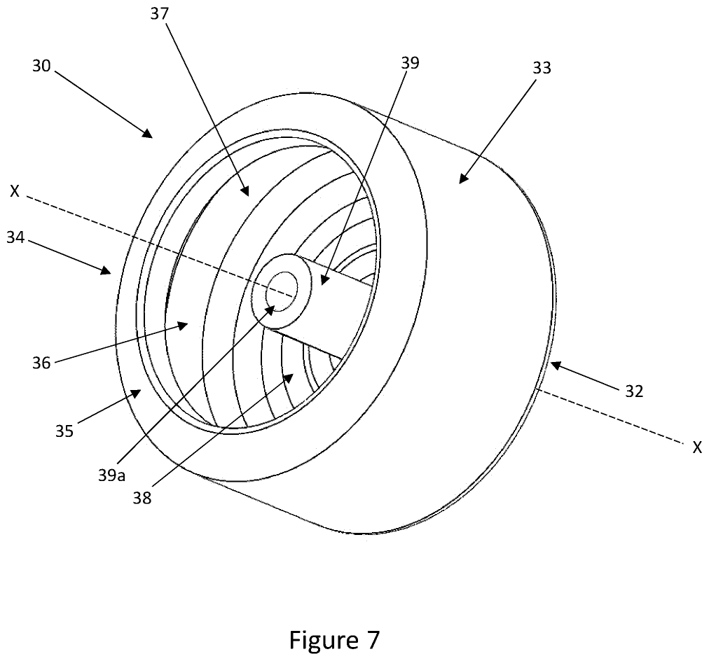

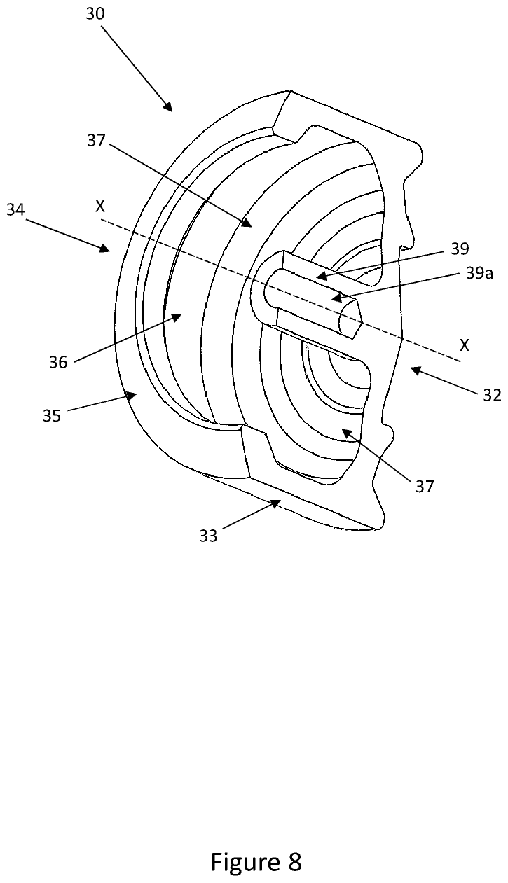

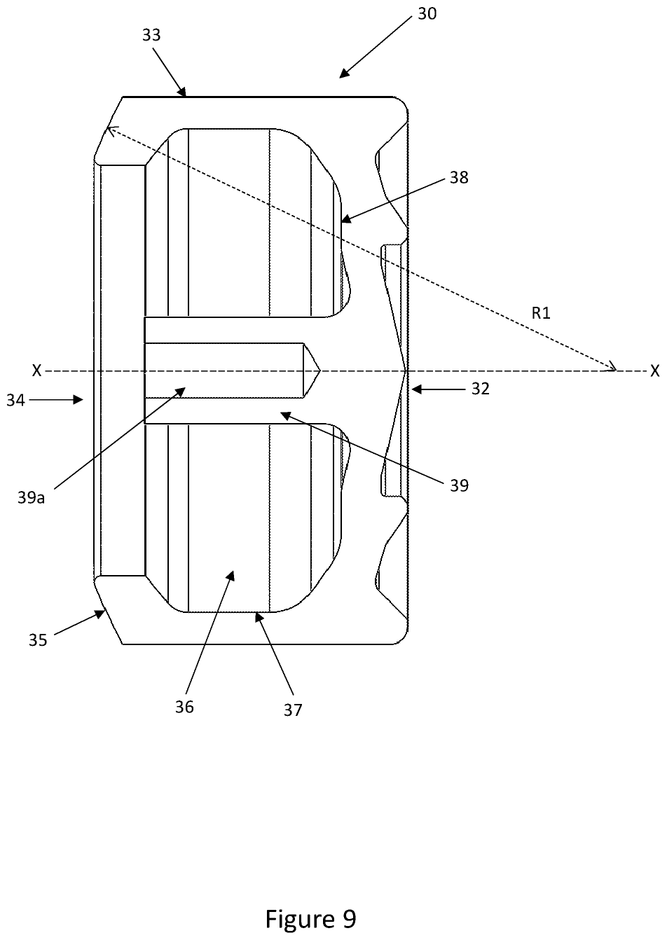

Piston body 30 is shown in FIGS. 7 to 9. The body 30 has a base end 32 and a pad end 34, with a cylindrical side wall 33 extending therebetween. The body 30 is formed symmetrically around an axis X. The pad end 34 has a cap contact surface 35. The cap contact surface 35 is at a non-perpendicular angle relative to the axis X. The angle of the cap contact surface 35 may be a fixed angle or it may be provided by a surface which is curved, defined by radius R1 with a notional centre on axis X. The face of the cap contact surface 35 has a controlled engineering surface, for example to increase the coefficient of friction e.g. by machining, abrasion treatment or knurling.

The body 30 is substantially hollow, the base end 32, side wall 33 and pad end 34 forming an interior space 36. The interior space 36 is further defined by an interior wall 37 and an interior base 38. The interior base 38 has a protrusion 39 extending therefrom, a threaded bore 39a (parallel to axis X) being formed in the protrusion 39.

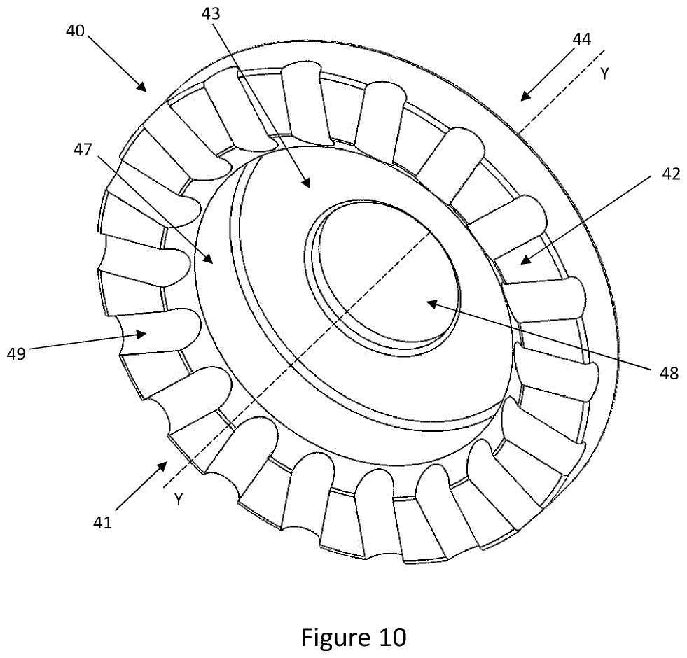

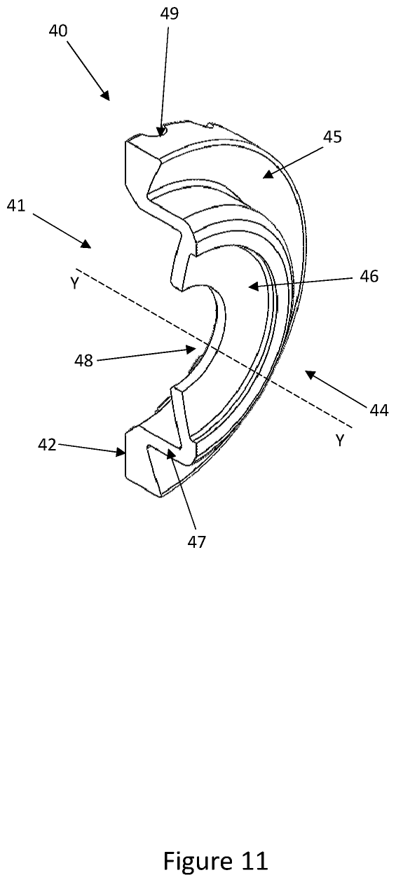

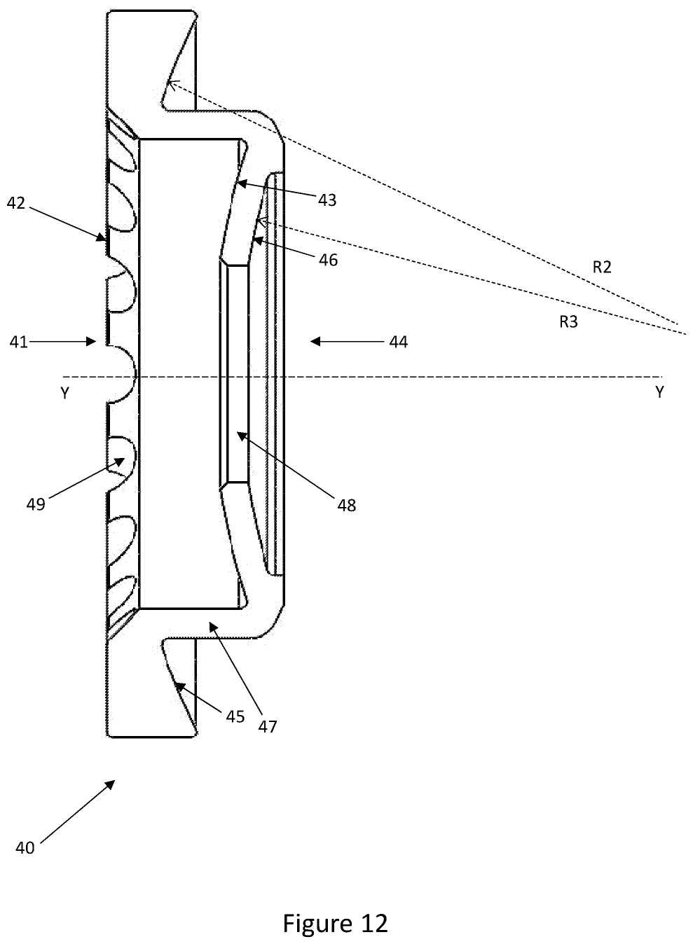

In FIGS. 10 to 12, the cap 40 has a first side 41 and a second side 44. The first side 41 has a pad contact face 42 and washer contact face 43. The second side 44 has a body contact face 45 and a spring contact face 46. The cap 40 is symmetrical about an axis Y. The pad contact face 42 is separated from the washer contact face 43 and the body contact face 45 is separated from the spring contact face 46 by a wall 47, which extends parallel to the axis Y.

The body contact face 45 has a non-perpendicular angle with respect to axis Y and, in the embodiment shown, is curved, defined by a radius R2 with a notional centre on axis Y similar to radius R1 of the cap contact surface 35 of the piston. The washer contact face 43 has a non-perpendicular angle with respect to axis Y and, in the embodiment shown, is curved, defined by a radius R3 with a notional centre on axis Y.

A hole 48 is formed through the cap 40, centred on the axis Y. The pad contact face 42 has grooves 49 formed therein, to allow passage of cooling airflow, whilst the body contact face 45 has a controlled engineering surface, for example to increase the coefficient of friction, such as those applied to the body contact surface 35 of the piston body 30.

Resilient member 50 takes the form of a conical spring. The securing means 60 is a conventional bolt. However, in other embodiments (not shown), there are envisioned other forms of resilient member 50, for example an elastomeric member such as a rubber bush, and other forms of securing means 60, for example a nut where the protrusion has an external screw thread. The resilient member 50 has a wide end 52 and a narrow end 54.

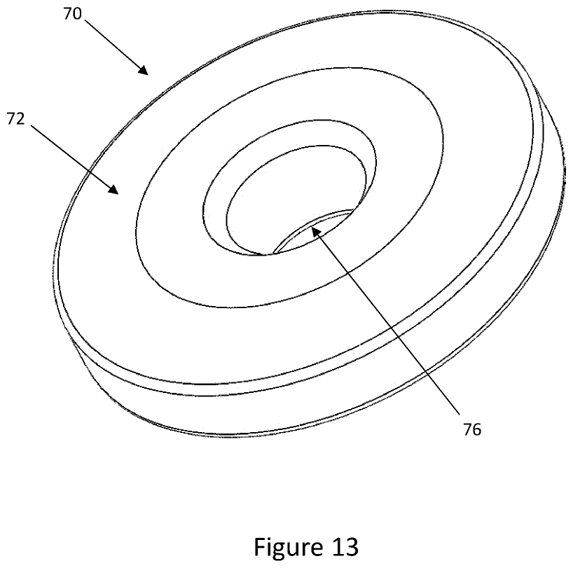

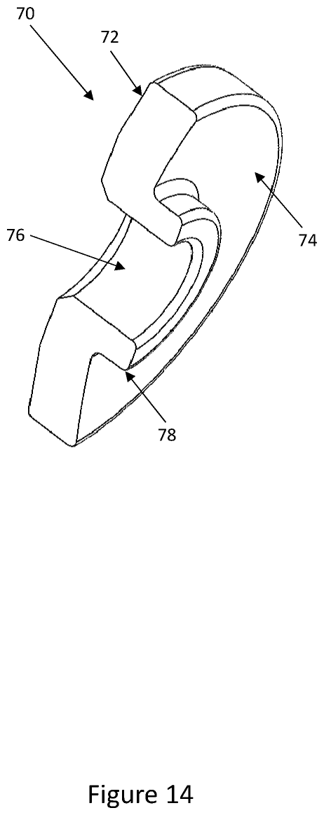

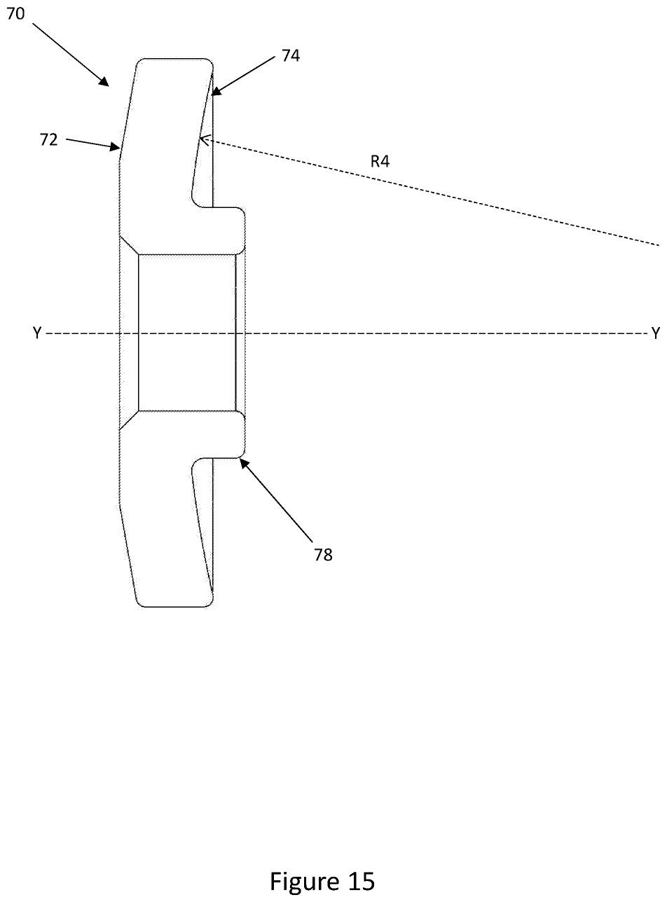

Washer 70 can be seen in FIGS. 13 to 15 and has a first face 72, a second face 74 and a hole 76 extending therethrough. The second face 74 has a protrusion 78 extending therefrom. The second face 72 of the washer 70 has a non-perpendicular angle with respect to axis Y and, in the embodiment shown, is curved, defined by a radius R4 with a notional centre on axis Y.

The radii R3 and R4 are the same as each other and are both less than the radii R1 and R2.

As shown in FIGS. 6 and FIGS. 16 to 18, the piston 20 is assembled as follows.

Firstly, the resilient member 50 is slid over the protrusion 39 of piston body 30 so that the resilient member 50 rests within the interior space 36 of the body 30. The resilient member 50 is inserted so that the narrow end 54 contacts the interior base 38 of body 30.

Then, the cap 40 is positioned over the piston body 30, such that the body contact face 45 of the cap 40 is arranged over the cap contact surface 35 of body 30. In this way, the wide end 52 of resilient member 50 is also in contact with the spring contact face 46 of cap 40. Furthermore, the hole 48 of cap 40 lines up with the protrusion 39, specifically the threaded bore 39a, of body 30.

Then, the washer 70 is aligned so that the second face 74 of the washer 70 contacts the washer contact face 43 of cap 40. In this way, the protrusion 78 of washer 70 passes through the hole 48 of cap 40 and lines up with the diameter of the protrusion 39 and the threaded bore 39a of piston body 30. It is noted that the protrusion 78 of washer 70 and the protrusion 39 of body 30 have the same diameter, as do the hole 76 of washer 70 and the threaded bore 39a of the protrusion 39 of the body 30.

Finally, the bolt 60 is used to moveably secure the cap 40 to the body 30. The bolt 60 is passed through the hole 76 of washer 70 and screwed into the threaded bore 39a of the protrusion 39 of the body 30. The bolt 60 is tightened to an extent to secure the cap 40 to the body 30 and to provide some frictional resistance to movement of the cap 40 relative to the piston body 30, both transversely and axially relative to the axis X of the body 30. This will be discussed in more detail below.

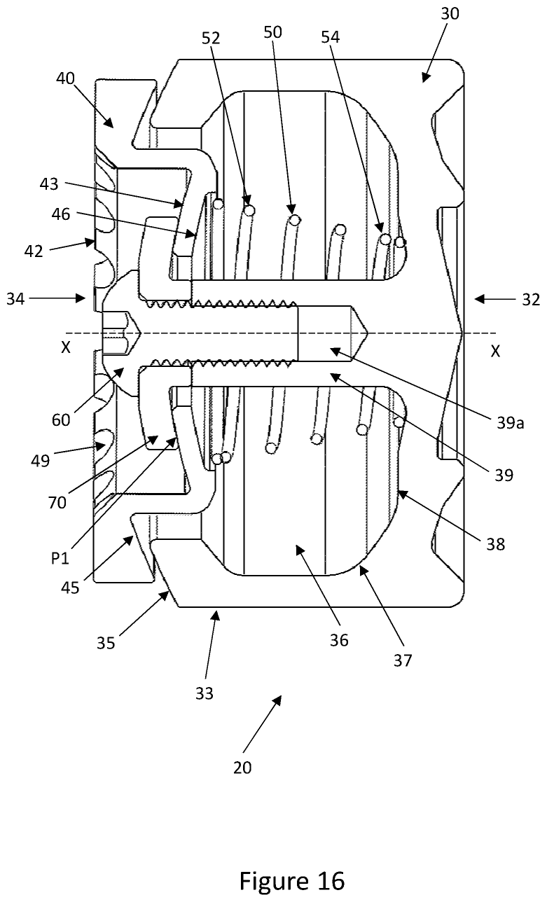

The function of the device is illustrated in FIGS. 16 to 18.

In an initial “brake off” position shown in FIG. 16, there is a space between the cap contact surface 35 of body 30 and the body contact face 45 of cap 40. There is also contact between the second face 74 of washer 70 and the washer contact face 43 of cap 40. This latter contact provides a frictional resistance to transverse movement of the cap 40 relative to axis X of the body 30. The resistive force provided by resilient member 50 ensures this contact and gap are maintained.

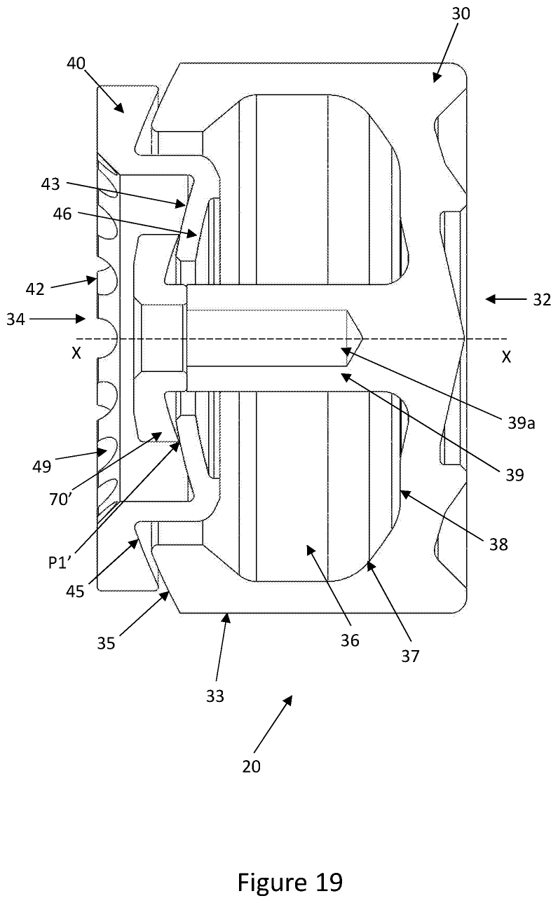

When the brake is operated, the piston 20 is forced towards the rear face of the pad 18. Where the disc facing surface 19a of the pad 18 is not parallel to the brake disc (see FIG. 19), as the pad 18 is pushed towards the brake disc and the pad 18 comes into contact with the disc, the angled disc facing surface 19a conforms to the surface of the disc which results in the piston facing surface 19b of the pad 18 being arranged at a non-zero angle to the front face of the brake piston or pistons 20, and consequently a non-perpendicular angle to the piston axis along which the braking force is applied. In a conventional brake system this would result in a reactive force being applied to the pistons at a non-zero angle relative to the piston axis.

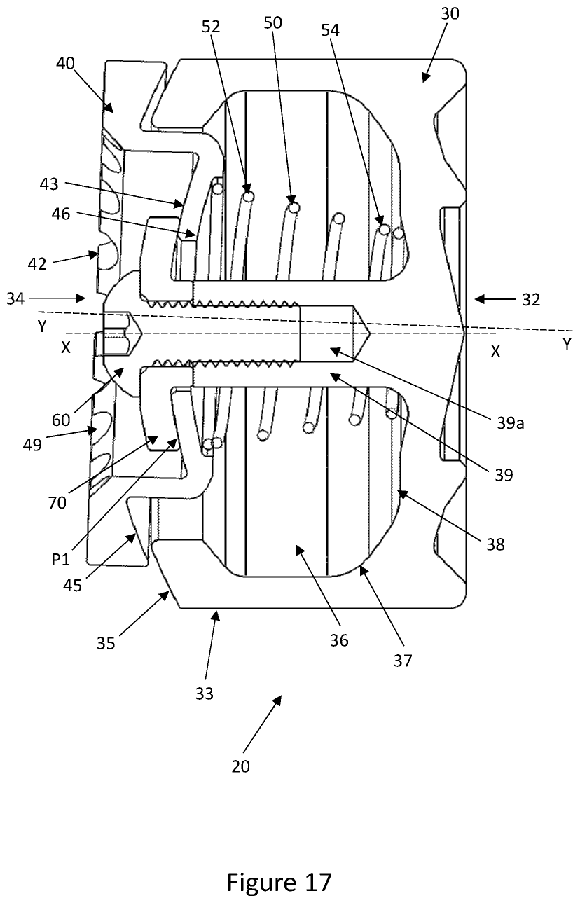

In the present invention, as the piston or pistons 20 apply pressure to the piston facing surface 19b of the pad 18 with an angled disc facing surface 19a, the reactive force instead applies a resultant force to the cap 40 transverse with respect to the axis X of the piston 20. When the resultant force is sufficient to overcome the frictional force between the washer contact face 43 of the cap 40 and the washer 70, the cap 40 moves transversely with respect to the axis X of body 30 at an angle or arc defined by the second face of the washer and the washer contact face of the cap. This intermediate position can be seen in FIG. 17. The gap between the cap contact surface 35 of body 30 and the body contact face 35 of cap 40 is maintained at this point by virtue of the fact that the radii R3 and R4 are less than R1 and R2 but the foci of rotation of each of the two sets of radii are the same. In other words, the curved surfaces of all of the body contact surface of the cap, the cap contact surface of the body, the second surface of the washer and the washer contact surface of the cap are concentric. In an alternative arrangement, all of the contact surfaces are formed at the same fixed, non-perpendicular angle with respect to the axis X. This also has the effect of ensuring that the gap between the cap contact surface 35 of body 30 and the body contact face 35 of cap 40 is maintained during transverse movement of the cap relative to the body.

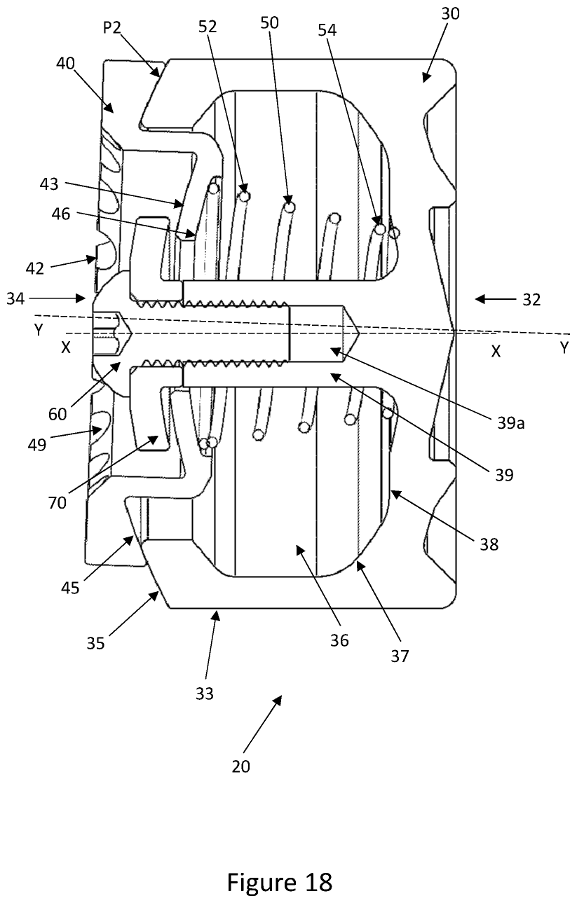

Then, upon further actuation of the piston 20, the conical spring 50 is compressed and the cap 40 moves axially with respect to the axis X of body 30 to a second position, as can be seen in FIG. 18. In this second position, there is contact between the body contact face 45 of the cap 40 and the body contact surface 35 of body 30. Likewise, there is a gap between the second face 74 of washer 70 and the washer contact face 43 of cap 40. The surface roughening features of the body contact surface 35 and the body contact face 45 mean that this position is maintained throughout the subsequent application of the braking force.

Upon release of the braking force, the piston 20 retracts and returns to the intermediate position shown in FIG. 17. The friction between the second face 74 of washer 70 and the washer contact face 43 of cap 40, created by the compressive force exerted by the conical spring 50 on the cap against the washer, ensures that the angle of the brake pad 18 is “remembered” by the cap 40 of piston 20. The conical nature of the resilient member 50 ensures that there is insufficient force provided by the resilient member 50 tending to return the cap 40 to its initial position to overcome the aforesaid friction.

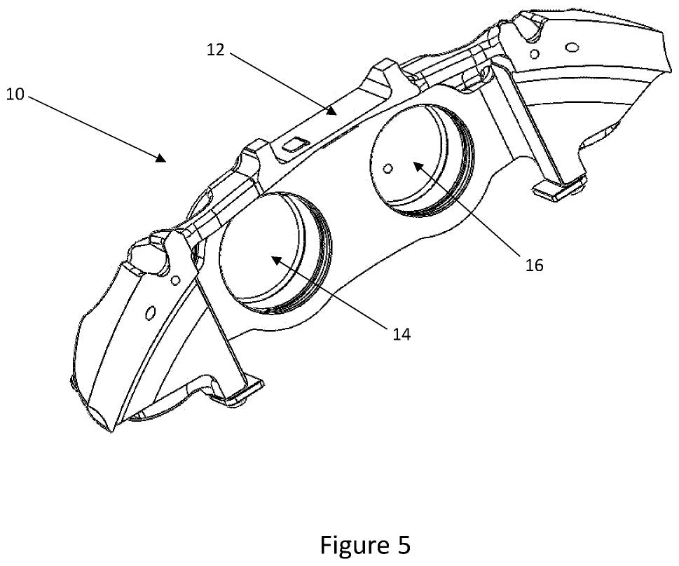

In a second embodiment, shown in FIGS. 19 and 20, the piston 20 is identical to that described with relation to FIGS. 5 to 18 above, except where described below. Parts in FIGS. 19 and 20 corresponding to parts in FIGS. 5 to 18 carry the same reference numbers. The spring 50 is omitted from the embodiment shown in FIGS. 19 and 20.

In the second embodiment, the focus of rotation of the radii of the second surface of the washer 70′ and the washer contact surface 43 of the cap is arranged closer to the pad end of the piston than the focus of rotation of the radii of the cap contact surface 35 of the body and the body contact surface 45 of the cap. This means that the path taken by the cap as it is displaced transverse to the axis when moving from the initial to the intermediate positions occurs at a steeper angle relative to the axis than that of the cap contact surface of the body.

In turn, this means that transverse displacement of the cap relative to the axis tends to close the gap between the cap contact surface 35 of body 30 and the body contact face 35 of cap 40. The gap and the relative angles described above can be arranged in such a way that displacement of the cap eventually closes the gap altogether, as shown in FIG. 20. In that way, no axial movement of the cap is required in order to bring the cap and body into contact.

The respective contact surfaces of the cap and the piston have engineered surfaces so that when the cap contacts the piston, a frictional fit is produced which causes the cap to be retained in the displaced position following release of brake pressure.

In that way, the spring is not required.

Aside from the change described above, the piston of the second embodiment functions the same as the first.

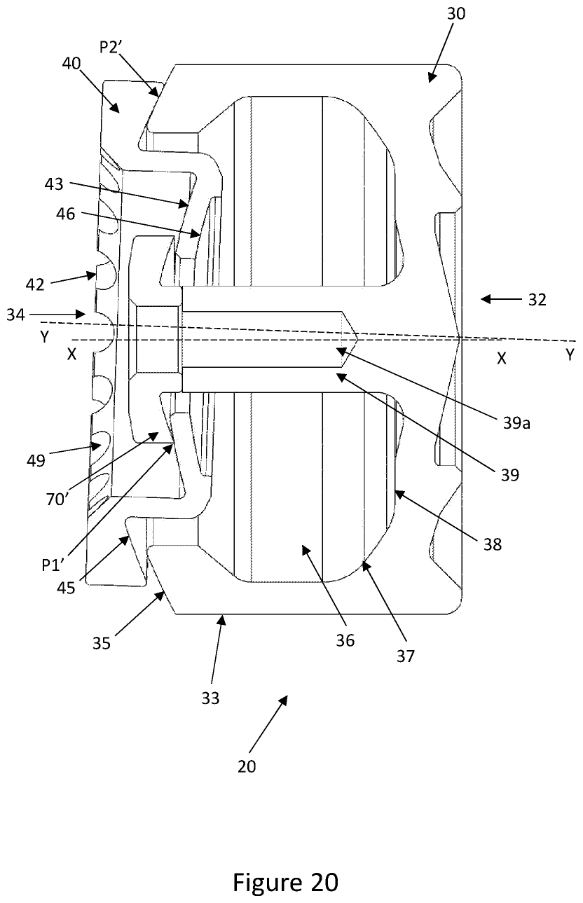

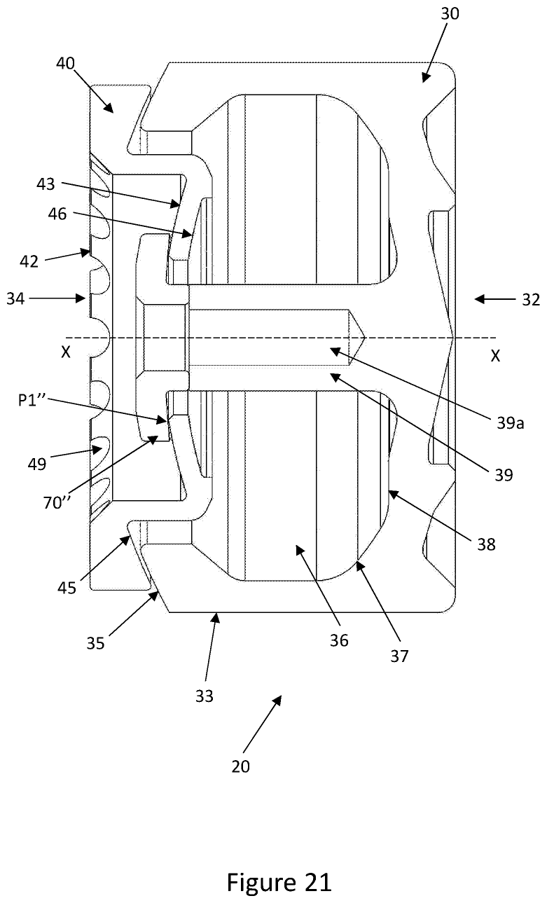

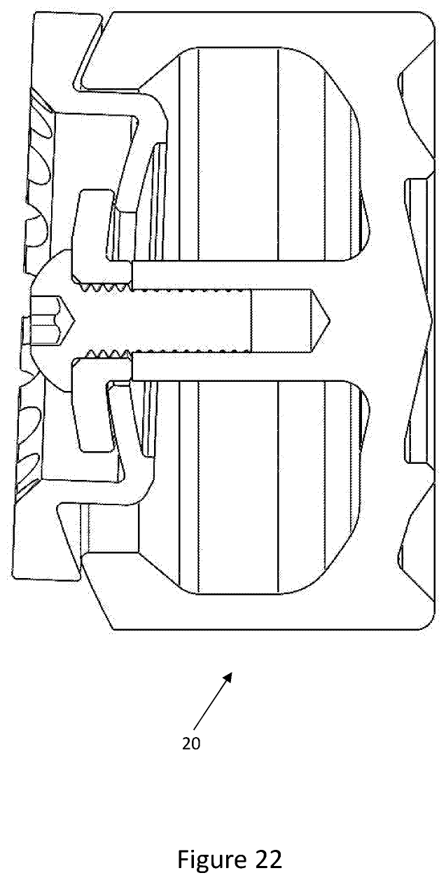

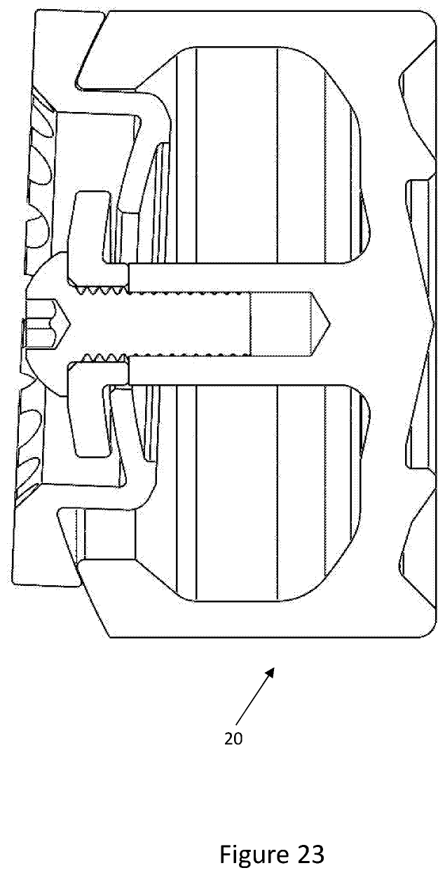

In a third embodiment, shown in FIGS. 21 and 22, the opposite arrangement to that described with respect to the second embodiment is provided. In particular, the washer contact surface of the cap 43 and the second surface 70″ of the washer extend at a shallower angle relative to the axis than the cap contact surface 35 of the body. In turn, this means that transverse displacement of the cap relative to the axis tends to increase the gap between the cap contact surface 35 of body 30 and the body contact face 45 of cap 40.

Such an arrangement may be preferred where transverse displacement of the cap over a wider range is required whereby maintaining clearance between cap and body over that range is important or where the surface roughening features are such that it is helpful to maintain clearance during transverse travel of the cap.

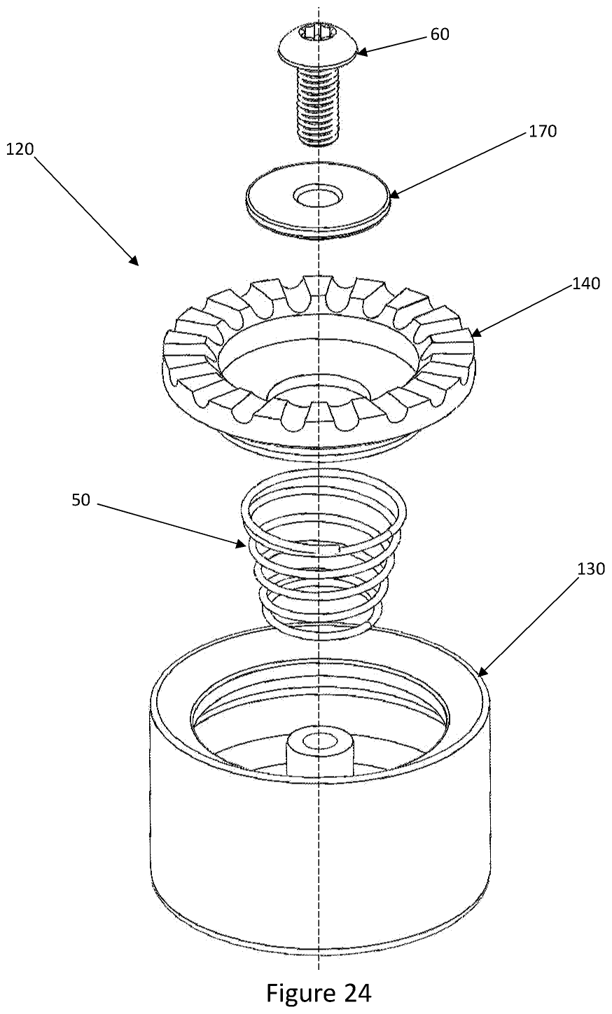

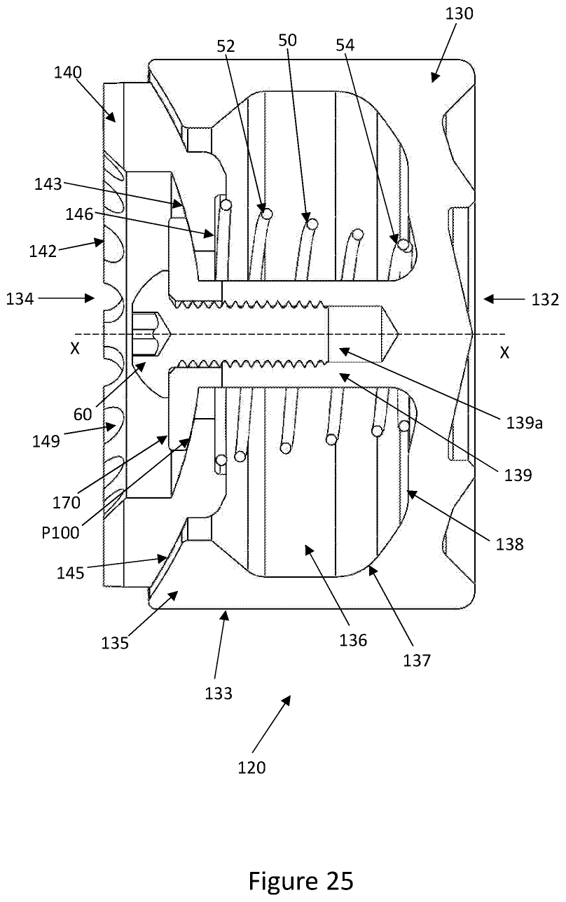

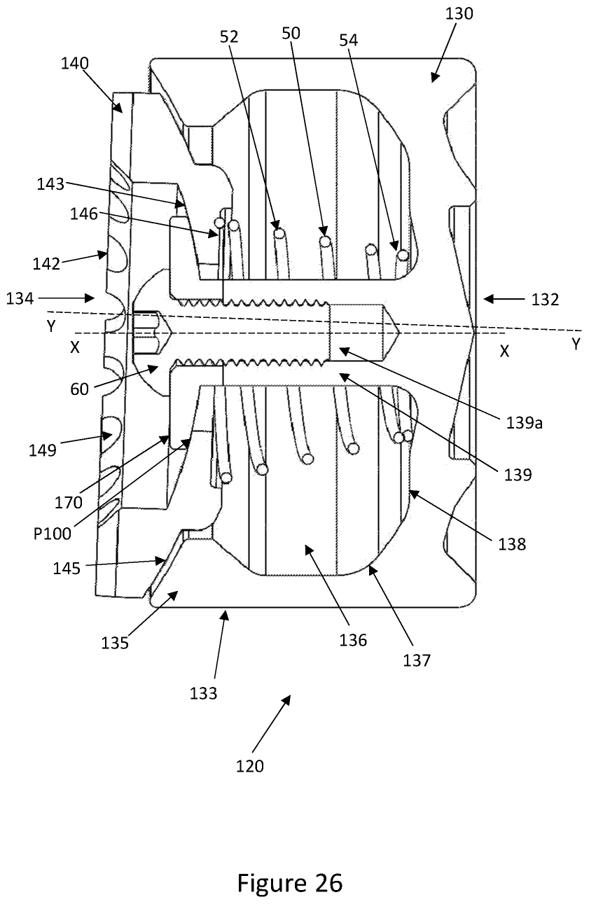

In a fourth embodiment, shown in FIGS. 25 to 28, an alternative “concave” piston is provided. In FIGS. 25 to 28, parts corresponding to parts in FIGS. 5 to 18 bear the same reference numeral with a “1” prefix.

The fourth embodiment is essentially the same as the first embodiment except that all of the angles of the contact surfaces on the cap 140, body 130 and washer 170 with respect to the axis X are inverted.

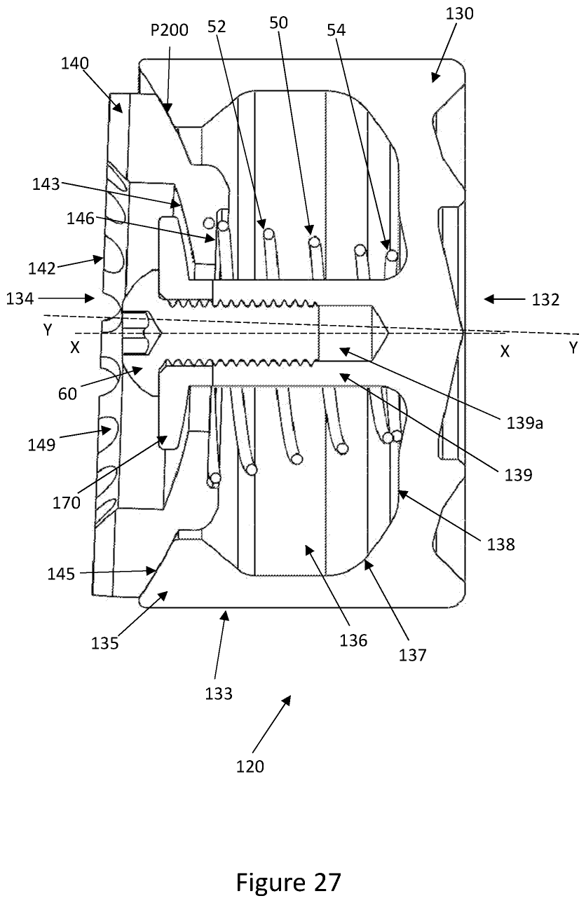

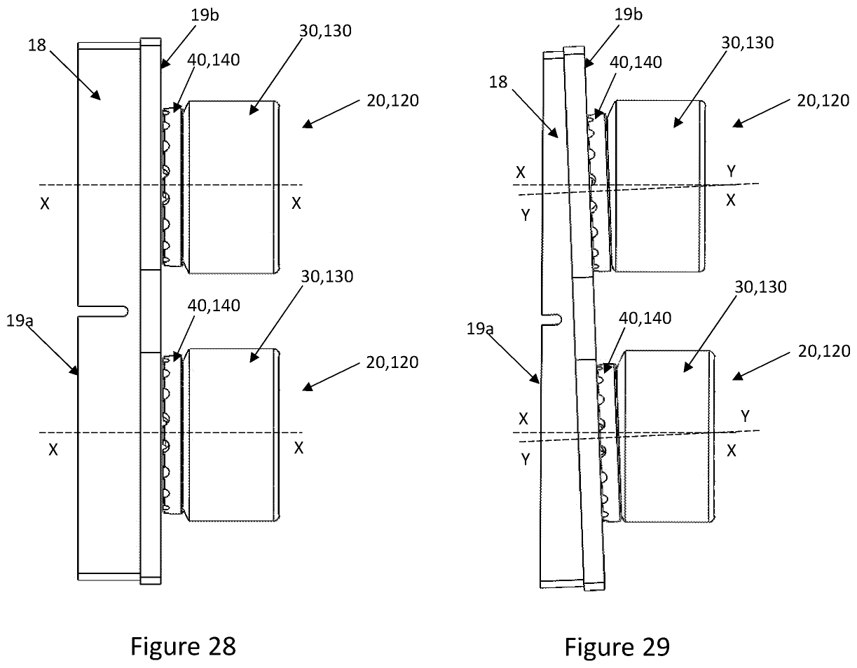

Finally, as shown in FIGS. 28 and 29, the pistons made in accordance with the invention have the advantage that the articulation of the piston cap ensures that the reactive force applied back through the piston on application of the brakes is much closer to parallel with the piston axis, which is preferable for the reasons described above.

1. A piston for the actuation of a brake pad, the piston comprising:
a body having a base end, a pad end and a side wall formed therebetween, an axis X extending from the base end to the pad end, the pad end having a cap contact surface at a non-zero angle relative to the axis of the body;
a cap movably secured to the body at the pad end, the cap being arranged over the cap contact surface and having a pad contact face and an opposite body contact face; and
a resilient member arranged between the body and the cap;
wherein, on application of a braking force, the cap is arranged in an initial position where the cap contact surface of the body is spaced apart from the body contact face of the cap, whereby the cap is moveable transversely relative to the axis of the body into an intermediate position; and
wherein the cap is moveable axially relative to the body from the intermediate position into a final position where the cap contact surface contacts the body contact face such that movement of the cap transversely relative to the axis of the body is restrained in the final position.

2. The piston of claim 1, wherein either the body contact surface or the cap contact face has a roughened texture.

3. The piston of claim 1, wherein both the body contact surface and the cap contact face have a roughened texture.

4. The piston of claim 1, wherein the angle of the transverse movement of the cap relative to the axis X is different to the angle of the body contact surface relative to the axis X.

5. The piston of claim 1, wherein the body contact surface is curved, the curve having a radius of curvature and a centre of curvature, the centre of curvature being on the axis X.

6. The piston of claim 5, wherein the transverse movement of the cap occurs on a radius of rotation, whereby the radius of rotation is non-equal to the radius of curvature of the body contact surface.

7. The piston of claim 1, wherein an angle of transverse movement of the cap relative to the axis is smaller than the angle of the body contact surface relative to the axis.

8. The piston of claim 1, wherein an angle of transverse movement of the cap relative to the axis is greater than the angle of the body contact surface relative to the axis.

9. The piston of claim 1, wherein the pad contact face of the cap has at least one groove formed therein.

10. The piston of claim 1, wherein the base end and side wall of the body define an interior space of the body.

11. The piston of claim 10, wherein the body has a protrusion extending from the base end into the interior space.

12. The piston of claim 10, wherein the resilient member is arranged within the interior space of the body.

13. The piston of claim 1, wherein the resilient member is a spring.

14. The piston of claim 13, wherein the resilient member is a conical spring having a wide end and a narrow end, the resilient member being arranged such the wide end is closer to the cap than the narrow end.

15. The piston of claim 13, wherein the resilient member is arranged such that it extends around the protrusion of the body and the body has a protrusion extending from the base end into the interior space.

16. The piston of claim 1, wherein the cap is movably secured to the body at the pad end via securing means.

17. The piston of claim 16, wherein the securing means is a bolt.

18. The piston of claim 17, wherein the securing means is a bolt that is screwed into a threaded bore in the pad end of the protrusion of the body and the body has a protrusion extending from the base end into the interior space.

19. The piston of claim 16, further comprising a washer arranged between the securing means and the cap.

20. The piston of claim 19, wherein the washer has a first face and a second face, the second face being in contact with the cap in the second position but not in the initial position.

21. The piston of claim 1, wherein the piston comprises a cap displacement retention mechanism which retains the transverse displacement of the cap relative to the body after release of the braking force.

22. The piston of claim 21, wherein the cap displacement mechanism comprised the cap, the resilient means and the washer, whereby the resilient means is arranged to urge the cap against the washer, in such a way that friction between the cap and the washer is insufficient to prevent transverse displacement of the cap relative to the body on application of braking force but is sufficient to prevent movement of the cap relative to the washer on release of braking force; and wherein a washer is arranged between the securing means and the cap.

23. A piston for the actuation of a brake pad, the piston comprising:
a body having a base end, a pad end and a side wall formed therebetween, an axis X extending from the base end to the pad end, the pad end having a cap contact surface formed at a first angle relative to the axis of the body;
a cap movably secured to the body at the pad end, the cap being arranged over the cap contact surface and having a pad contact face and an opposite body contact face, the cap being arranged to move transversely relative to the axis at a second angle;
the second angle being less than the first angle, such that, on application of a braking force, the cap is arranged to move transversely relative to the axis from an initial position where the cap contact surface of the body is spaced apart from the body contact face of the cap, into a final position where the body contact surface contacts the cap contact surface,
one or both of the cap contact surface or body contact surface having a roughened surface such that movement of the cap transversely relative to the axis of the body is restrained in the final position by friction between the cap contact surface and the body contact surface.

24. A brake caliper assembly including the piston of claim 1.

25. A vehicle including the brake caliper assembly of claim 24.

26. The piston of claim 14, wherein the resilient member is arranged such that it extends around the protrusion of the body and the body has a protrusion extending from the base end into the interior space.
